(19) United States
(12) Patent Application Publication
(10) Pub. No.: US 2023/0325370 A1
(43) Pub. Date: Oct. 12, 2023

(54) DETERMINATION OF DATA PARAMETERS BASED ON DISTRIBUTION OF DATA FOR PRIVACY PROTECTION

(71) Applicant: Hewlett-Packard Development Company, L.P., Spring, TX (US)

(72) Inventors: Sagar Sharma, Vancouver, WA (US); Mike Alan Holmberg, Boise, ID (US)

(21) Appl. No.: 18/023,375

(22) PCT Filed: Oct. 1, 2020
(86) PCT No.: PCT/US2020/053830

§ 371 Date: Feb. 26, 2023

(51) Int. Cl. G06F 16/22; G06F 21/62

(52) U.S. Cl. CPC G06F 16/2228; G06F 21/6227

(57) ABSTRACT

An example system includes a bin generator engine to divide a range of data into bins of equal size; and populate the bins with the data, the bins comprising a first data structure stored in a memory. The example system further includes a sub-bin generator engine to: sub-divide the bins into respective sub-bins based on a relative frequency of the data in the bins; and populate the sub-bins with the data or further data, the sub-bins comprising a second data structure stored in the memory. The example system further includes a data parameter engine to: reconstruct the data, or the further data, based on the sub-bin distribution of the data/further data; and determine a parameter of the data/further data, based on the data/further data, as reconstructed from the distribution into the sub-bins, the parameter being stored, at least temporarily in the memory or transmitted to an external device.

### BACKGROUND

Data collection and analysis in many environments is performed to balance utility of collected data with privacy of the collected data, which may be performed by introducing randomization and/or noise into the data, a concept known as differential privacy.

### BRIEF DESCRIPTION OF THE DRAWINGS

Reference will now be made, by way of example only, to the accompanying drawings in which:

FIG. 1 is a block diagram of an example system to determine data parameters based on distribution of data.

FIG. 2 is a block diagram of another example system to determine data parameters based on distribution of data.

FIG. 3 is a flow diagram of an example method to determine data parameters based on distribution of data.

FIG. 4 is a block diagram of an example computer-readable medium including instructions that causes a processor to determine data parameters based on distribution of data.

FIG. 5 is an example of a method to determine data parameters based on distribution of data.

### DETAILED DESCRIPTION

Data collection and analysis in many environments is performed to balance utility of collected data with privacy of the collected data, which may be performed by introducing randomization and/or noise into the data, a concept known as differential privacy. For example, system and devices adapted to implement data collection according to differential privacy may be understood to include systems and/or devices that determine a parameter and/or parameters (e.g., statistical parameters) from data collected by data collection devices, without compromising privacy of data collected from individual devices and the associated users. While a localized addition of a quantifiable amount of randomization and/or noise to the collected data (e.g., at the data collection devices) may be used to protect such privacy and/or identity, such randomization and/or noise may not be sufficient to protect privacy and/or achieve data utility. In particular, for some distributions of collected data, including, but not limited to, non-symmetric and/or skewed distributions of collected data such randomization and/or noise may change values of the parameter and/or parameters being determined from the collected data to a degree where the determined parameter and/or parameters may have a high degree of error. Similarly, while the collected data may be binned to further protect privacy of the data, simple binning techniques may again result in a high degree of error in a parameter and/or parameters being determined from the collected data.

As such, provided herein, are systems, methods, and devices to determine data parameters based on distribution of data, as described herein For example, a system is provided, which may receive data from a data collection device, and/or data collection devices, and divide a range of the data into bins of about equal size and/or width (e.g., though the bins may not be exactly equal in size and/or width). The system populates the data into the bins based on values of the data as compared to respective ranges of the bins. The population of the data into the bins hence represents a distribution of the data; for example, the data may be symmetrically distributed or unsymmetrically distributed. As mentioned above, however, such a simply binning technique may result in a high degree of error in a parameter and/or parameters being determined from the data.

Hence, the system divides the bins into sub-bins based on a relative frequency of the data in the bins; for example, the bin with highest frequency of the data is sub-divided into the highest number of sub-bins, the bin with lowest frequency of the data is sub-divided into the lowest number of sub-bins, and bins between the highest and lowest frequency bins are subdivided accordingly. Within a bin, the sub-bins may have about equal sizes and/or widths, however sizes and/or widths of the sub-bins vary from bin to bin, with relatively smaller sub-bins in the bins with higher frequencies of data and relatively larger sub-bins in the bins with lower frequencies of data.

The system again distributes the data, and/or further data received from the data collection devices, into the sub-bins, again based on values of the data and/or the further data, as compared to respective ranges of the bins. In a particular example, the bins and sub-bins may be generated from an initial set of data received from the data collection devices, and indications of the sub-bins may be provided to data collection devices which distribute further data and/or new data into the sub-bins; in particular, the initial set of data may be a smaller data set than the further data and/or new data.

The distribution of data into the sub-bins may result in a histogram, and the like, that shows more detail of the data than if only distributed into the bins, which may result in a more accurate determination of statistical parameters (and the like) of the data, while still maintaining privacy of the data.

Data parameter and/or parameters may be determined from the data as distributed in the sub-bins; such a parameter and/or parameters may include, but is not limited to, any suitable statistical parameters such as a mean of the data, a standard deviation of the data, and the like. In particular, a determination of such a parameter and/or parameters and/or statistical parameters may be more accurate than if determined from the data, as collected, as distributed only into the bins and/or than if determined from the data, as collected with addition of a quantifiable amount of randomization thereto.

Put another way, while such a parameter and/or parameters and/or statistical parameters could be most accurately determined from the raw data, the raw data is lacking in privacy. Hence, the sub-binning technique described herein results in a determination of such parameter and/or parameters and/or statistical parameters that is relatively close the same parameter and/or parameters and/or statistical parameters determined from the raw data. Indeed, the term “accuracy” as used herein may be understood to include a comparison of a parameter determined from collected data with the sub-binning technique described herein applied thereto, as compared to the parameter determined from the collected data in a raw state (e.g., with no randomization or binning applied). Hence, the sub-binning technique described herein balances utility of the data (e.g., accuracy of a parameter determined from the data as sub-binned) with privacy of the data, and hence may be referred to a differential privacy determination of data parameters based on distribution of data. In particular, the data, as distributed into the sub-bins, may represent the data with details of the raw data (e.g., as collected from the data collection devices) removed. For example, the data, as distributed into the sub-bins, may be transformed into a histogram format so that only numbers of data points of the raw data (and/or as randomized) in the sub-bins result, with the raw data otherwise discarded. The histogram may represent a reconstruction of the data but with details of the raw data removed, and/or may be used, to reconstruct the data with details of the raw data removed.

As such, the sub-bins may alternately be referred to as optimized bins and/or finer bins (e.g., optimized and/or finer relative to the bins from which the sub-bins are determined), and the like.

In particular, it is understood that the bins and the sub-bins referred to herein comprise data structures generated by systems and devices described herein, and/or hardware of such systems and devices. Similarly, the term “binning” is understood to include a method and/or a process of distributing data, collected by data collection devices described herein, into the bins and/or sub-bins described herein.

Furthermore, it is understood that accurate reconstruction of the data, with details removed to protect privacy, may be important as the data, as reconstructed may be used, not only for shipping supplies, and the like, but also for generating business insights and trends across similar users (e.g., of the data collection devices) while maintaining privacy of those users. Put another way, it is important to remove details of raw data collected by the data collection devices, for example in reconstructed data determined using the sub-bins, while maintaining utility of the reconstructed data so that trends, and the like, of the reconstructed data may be determined and/or used to implement real-world changes to hardware (e.g., which may include, but is not limited to, shipping supplies to the data collection devices) but without comprising privacy of users of the data collection devices.

The data collection devices may include any suitable devices from which data is to be collected and analyzed to determine parameters thereof while effectively preserving privacy of the data collection devices and/or privacy of users thereof. The parameters determined from the data (e.g., as distributed into the sub-bins and/or as reconstructed therefrom) may be used in any suitable manner, including, but not limited to, generating reports based on the parameters and/or shipping supplies to the data collection devices, and/or determine demand for the data collection devices (e.g., including, but not limited to, determining volumes for, and/or timing of, manufacturing the data collection devices), among other possibilities. In a particular example, the data collected therefrom may indicate use of supplies for operating the data collection devices. In a more specific example, the data collection devices may include printer devices and data collected therefrom may indicate use of supplies for operating the printer devices, such as use of paper and/or ink; in this more specific example, the parameter and/or parameters and/or statistical parameters may indicate a mean usage of paper and/or ink and/or a mean rate of usage of paper and/or ink, which may be used to determine when to ship paper and/or ink to locations of the printer devices. In yet a further specific example, the parameter and/or parameters and/or statistical parameters may be used to determine a number of data collection devices (e.g., printers) to manufacture per model category.

However, the data collection devices may be any suitable devices including, but not limited to, Internet-of-Things (IoT) devices (e.g., thermostats, appliances, etc.), personal computers, laptop computers and/or any other suitable devices that may collect data regarding operation of the devices, and which may communicate with the components of a system for determining data parameters based on distribution of data collected by the devices. Furthermore, while the parameter and/or parameters and/or statistical parameters may indicate usage of supplies by data collection devices, the parameter and/or parameters and/or statistical parameters may generally indicate operational factors of the data collection devices (e.g., power usage, bandwidth usage, and/or any other suitable operational factor, including, but not limited to, operational factors that may be related to users of the data collection devices, such as operational factors related to user behavior and/or preferences when operating a data collection device, which may include demographics of the users (age, gender, etc.) and the like) and may be used to generate (e.g., and transmit reports) regarding such operational factors.

An aspect of the present specification provides a system comprising: a bin generator engine to: divide a range of data into bins of equal size; and populate the bins with the data, the bins comprising a first data structure at least temporarily stored in a memory; a sub-bin generator engine to: sub-divide the bins into respective sub-bins based on a relative frequency of the data in the bins; and populate the sub-bins with the data or further data, the sub-bins comprising a second data structure at least temporarily stored in the memory; and a data parameter engine to: reconstruct the data, or the further data, based on distribution of the data, or the further data into the sub-bins; and determine a parameter of the data, or the further data, based on the data, or the further data, as reconstructed from the distribution into the sub-bins, the parameter being stored, at least temporarily in the memory or transmitted to an external device.

Another aspect of the present specification provides a method comprising: receiving, at a data collection device, an indication of sub-bins into which data is to be distributed, the sub-bins being subdivisions of larger bins sub-divided into respective sub-bins based on a relative frequency of previous data in the bins as collected from the data collection device, or other data collection devices; storing, at a memory of the data collection device, the sub-bins as a data structure; collecting, at the data collection device, the data in a raw form; distributing, at the data collection device, the data into the sub-bins such that the data, as distributed into the sub-bins, represents a reconstruction of the data, while removing details of the data in the raw form; and transmitting, using a communication interface of the data collection device, to a data collection engine at a server, the data as distributed into the sub-bins.

Another aspect of the present specification provides A non-transitory computer-readable medium comprising instructions that, when executed by a processor, cause the processor to: execute a bin distribution module to: provide, to data collection devices, an indication of respective sub-bins, the sub-bins being subdivisions of bins sub-divided into respective sub-bins based on a relative frequency of previously collected data in the bins, as collected from the data collection devices; execute a data collection module to: receive collected data from the data collection devices, as distributed into the respective sub-bins; execute a data parameter module to: determine a parameter of the collected data based on distribution of the collected data into the sub-bins; and execute a shipping-transmit module to: cause shipping or transmission of items to locations based on the parameter.

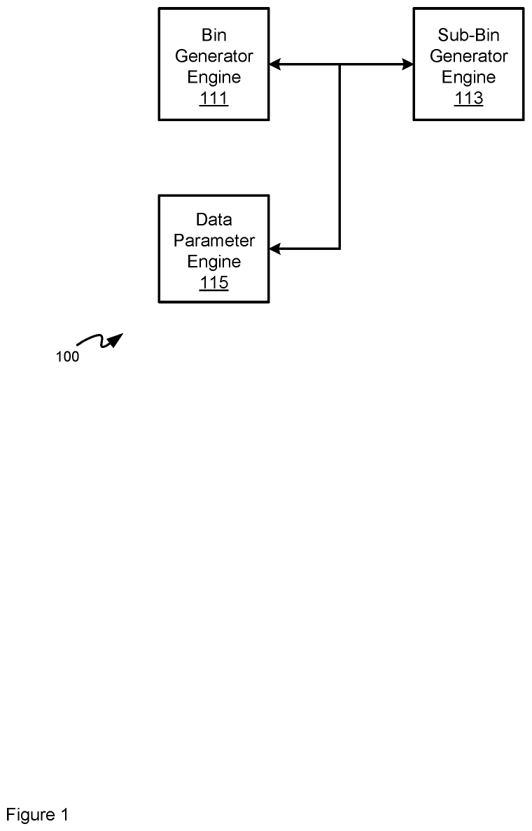

FIG. 1 is a block diagram of an example system 100 to determine data parameters based on distribution of data. The system 100 includes a bin generator engine 111, a sub-bin generator engine 113, and a data parameter engine 115. Communication between components and/or engines described herein is shown in the figures of the present specification as arrows therebetween.

As used herein, the term “engine” refers to hardware (e.g., a processor, such as a central processing unit (CPU) an integrated circuit or other circuitry) or a combination of hardware and software (e.g., programming such as machine- or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

For example, the bin generator engine 111 may comprise hardware or a combination of software and hardware for implementing functionality to: divide a range of data into bins of equal size; and populate the bins with the data, the bins comprising a first data structure at least temporarily stored in a memory. The bin generator engine 111 may comprise a portion of a server and/or computing device, which hosts the bin generator engine 111. However, the bin generator engine 111 may comprise hardware or a combination of software and hardware of any suitable server and/or computing device and/or more than one suitable server and/or computing device.

Furthermore, the bins are understood to comprise a data structure (e.g., a first data structure) which may be at least temporarily stored in a memory of the system 100 (not depicted) for later use by engines of the system 100 in distributing data, as described hereafter.

In particular, the bin generator engine 111 may receive data from a data collection device and/or data collection devices (not depicted) via a data collection engine (not depicted) and/or any suitable combination of communication networks (e.g., the Internet, WiFi networks, wide area networks (WANs), local area networks (LANs), and the like) and/or communication links with the data collection devices, and the like. Alternatively, the data from a data collection device and/or data collection devices may be stored at a memory accessible to the bin generator engine 111.

While examples are presently described with respect to data being collected by, and received from, a plurality of data collection devices, data may be collected by, and received from, as few as one data collection device.

The data received may be collected by the data collection devices and indicate operational factors (as described above), and the like, of the data collection devices and/or usage of supplies, and the like, by the data collection devices, for which a parameter and/or parameters and/or statistical parameters may be determined, using the data. Such parameter and/or parameters and/or statistical parameters may indicate a mean and/or a standard deviation of an operational factor and/or a mean and/or a standard deviation of usage of supplies, as described in more detail below. Individual data points in the data may be received in a univariate format and/or any other suitable format (e.g., which may be multi-dimensional, such as an “XY” format, an “XYZ” format, and the like). Hence, while examples provided herein show an “XY” format of data, it is understood that other formats of data are within the scope of the present specification.

In a particular example, the data collection devices may comprise printer devices, and the data may indicate frequency of usage of numbers of pages of paper and/or amounts of ink at the printer devices. For example, the data may include data points that indicate frequency of numbers of pages of paper used for particular printing jobs and/or for particular time periods (e.g., number of pages printed per day). The data may alternatively include data points that indicate frequency of amounts (e.g., in droplets of a given size, and the like) of ink used for particular printing jobs and/or for particular time periods (e.g., amount of ink used per day). Such data may be in a univariate format.

However, in other examples the data may include data points that indicate numbers of pages of paper used for particular printing jobs as a function of amounts of ink used for the particular printing jobs, with an “X” value of a data point being ink used for a particular printing job and a “Y” value of a data point being paper used for the particular printing job. Such data may be in an “XY” format.

However, the data may indicate any suitable factors of a data collection device.

In some examples, the bin generator engine 111 may introduce randomization and/or noise may into the data when binning the data, as described below according to a “Randomized Response Mechanism” and the like. Such a Randomized Response Mechanism may include generating more than one data point from a single data point, and the more than one data point may be binned. However, any suitable process may be used to may introduce randomization and/or noise may into the data for example by randomly adding or subtracting quantifiable values to data points in the data (e.g., the data points may be individually and randomly increased or decreased within a quantifiable given range; for example, the data points may be individually and randomly increased or decreased within a range of −5% to +5%). Such a processes may alternatively be referred to as dithering, and the like. In examples where randomization occurs via randomly adding or subtracting quantifiable values to data points in the data, the randomization may occur at the data collection devices. However, in other examples, the data may not be randomized and/or dithered. Furthermore, as will be described below, when indications of sub-bins are provided to data collection devices, the data collection devices may introduce randomization and/or noise may into data when binning the data, according to the “Randomized Response Mechanism”.

Regardless of whether or not the data is randomized and/or dithered, and/or regardless of whether or not the data is randomized and/or dithered by the bin generator engine 111 and/or the data collection devices, the bin generator engine 111 divides a range of the data into a number of bins of equal size and/or about equal size.

For example, the bin generator engine 111 may set a range of the data as extending between a maximum value of the data and a minimum value of the data, and divide the range by a given number to determine a size and/or width of a bin. The given number may be selectable and/or changeable by an administrator of the system 100 and/or the given number may depend on the range of the data and the like (e.g., with the given number increasing or decreasing as the range exceeds, or does not exceed, threshold range values and/or various threshold range values). In some examples, the bin generator engine 111 may increase the range past the maximum value of the data and/or decrease the range below the minimum value of the data, for example by 10%, 20% and/or any other suitable value, to account for later data being collected being larger or smaller than the maximum and minimum values.

However, such an increase or decrease may be limited by given rules applied by the bin generator engine 111; for example, one example of such a given rule is that the range may not extend into negative values for some types of data, and/or the range may have a lowest minimum of “0”, and the like. In a particular example, when the data represents frequency of usage of paper (and/or ink, and the like), negative values of such usage may be prohibited. Other rules may be applied to the range depending, for example, on whether or not negative data points are possible for the data. Similar rules may be applied to a maximum value for the range; for example, physical maximum limits on paper usage may be determined from tray sized of printers.

The range may be determined by the bin generator engine 111 from data initially collected by the data collection devices, in an initial provisioning mode, which may provide a representative sample of the data. However, the range may be adjusted accordingly in the event the representative sample of the data may not fully represent further data that is later collected by the data collection devices. Put another way, expanding a range, determined from initially collected data, by 10%, 20% and/or any other suitable value (e.g., and which may be limited by given rules, as described above), may assist with capturing outliers of further data collected by the data collection devices.

Furthermore, the initial data may comprise any suitable number of data points that may be predetermined to comprise a representative sample of the further data collected by the data collection devices. For example, such a suitable number may be hundreds to thousands of data points and/or any other suitable number.

Returning to determination of the bins by the bin generator engine 111, the bins are understood to be of equal size, however the term “equal size” may include, but is not limited to, bins of about equal size but not exactly equal size; in some examples, however, some of the bins may be slightly smaller or larger than others of the bins. For example, when dividing the range into bins, respective maximum and/or minimum values of a bin may be rounded up or down by the bin generator engine 111, which may result in the bins being of about equal size but not exactly equal. Furthermore, a last or first bin maybe larger or smaller than the other bins.

The bins being about equal size may alternatively be referred to as the bins being of equal width and/or about equal width and/or the bins may be referred to as equi-width bins.

In general, the bins start at a minimum value of the range and consecutively extend to the maximum value of the range. Furthermore, the individual bins are understood not to overlap, but the individual bins may cover the entire range, such that a single data point of the data and/or further data received from the data collection devices, may be placed into one of the bins, and may not fall between a bin and further may not be placed into more than one of the bins. Similarly, when more than one data point is produced during the Randomized Response Mechanism, a single data point, of more than one data point produced during the Randomized Response Mechanism (as previously described), may be placed into one of the bins, and may not fall between a bin and further may not be placed into more than one of the bins. Put another way, it is understood that adjacent “edges” of the bins (e.g., respective minimum and maximum values of bins) are adjacent one another without overlap therebetween.

In particular, once a range of the data is determined, and a width of the bins is determined (e.g., the range divided by the given number), a respective minimum value of a first bin may be set to the minimum value of the range, and respective maximum value may be the minimum value with the width added thereto. A respective minimum value of a second bin may be set to the respective maximum value of the first bin. When the bins are of about equal, but not exactly equal sizes (e.g., due to rounding), respective widths of adjacent bins may be used to determine respective minimum and maximum values of the adjacent bins.

In general, once the bin generator engine 111 determines the bins, the bin generator engine 111 populate the bins with the data. For example, the bin generator engine 111 may determine values of data points of the data and populate the bins based on which of the bins into which a given value of a given data point falls. As described above, such population may include using a Randomized Response Mechanism.

However, while respective minimum and maximum values of adjacent bins may be coincident, the bin generator engine 111 may populate the bins with the data, such that when a given data point of the data has a value that is equal to respective minimum and maximum values of adjacent bins, the bin generator engine 111 may place the data point into a bin, of the adjacent bins, that includes a relatively lower portion of the range. However, any suitable scheme may be used to resolve such collisions; in another example, when a given data point of the data has a value that is equal to respective minimum and maximum values of adjacent bins, the bin generator engine 111 may place the data point into a bin, of the adjacent bins, that includes a relatively higher portion of the range. In yet further examples, when a given data point of the data has a value that is equal to respective minimum and maximum values of adjacent bins, the bin generator engine 111 may randomly place the data point into one of the adjacent bins.

Regardless of how such collisions between adjacent bins are resolved, population of the data into the bins may allow and/or enable the sub-bin generator engine 113 to determine a relative frequency of the data in the bins.

For example, the sub-bin generator engine 113 is generally to: sub-divide the bins into respective sub-bins based on a relative frequency of the data in the bins; and populate the sub-bins with the data or further data, the sub-bins comprising a second data structure at least temporarily stored in the memory of the system 100.

Hence, like the bins, the sub-bins are understood to comprise a data structure (e.g., a second data structure) which may be at least temporarily stored in a memory of the system 100 (not depicted) for later use by engines of the system 100 in distributing data and reconstructing the data, as described hereafter. In some examples, the sub-bin generator engine 113 may replace, at a memory of the system 100, the first data structure (e.g., of the bins) with the second data structure (e.g., of the sub-bins). However, in other examples both of the first data structure (e.g., of the bins) and the second data structure (e.g., of the sub-bins) may be maintained at a memory of the system 100. Regardless, at least by generating and storing the bins and the sub-bins, the system 100 makes a tangible physical change to a least a memory of the system 100.

Details of generation of the sub-bins is now described in more detail. For example, the sub-bin generator engine 113 may determine the relative frequency of the data in the bins as ratios of data as distributed between the bins, rounded to integer values. For example, the sub-bin generator engine 113 may determine a bin (and/or bins) with a smallest frequency of data points, and sub-divide the bin (and/or bins) into the sub-bins and/or a minimum number of sub-bins (e.g., which may include as few as one sub-bin). Regardless, the bin with the smallest frequency of data points is sub-divided into a smallest number of sub-bins. Then, to sub-divide the bins (and/or bins) having a next smallest frequency of data points, the sub-bin generator engine 113 may multiply the number of sub-bins in the bin (and/or bins) with the smallest frequency of data points by a ratio of the frequencies of data points in the bins with: a next smallest frequency. and the smallest frequency of data points (e.g., rounded to an integer value). Such a process may continue until the bin (and/or bins) with the largest frequency of data points is sub-divided. Put another way, the bin (and/or bins) with the largest frequency of data points is sub-divided into the largest number of sub-bins, and the bin (and/or bins) with the smallest frequency of data points is sub-divided into the smallest number of sub-bins, with bins in between having respective numbers of sub-bins depending on the frequency of data points therein, relative to the bins with the largest and smallest frequency of data points. Furthermore, bins with similar and/or a same frequency of the data points may have a similar and/or same number of sub-bins.

However, the sub-division of the bins into the sub-bins may occur in any suitable manner that depends on the relative frequency of the data in the bins. For example, the sub-bin generator engine 113 may determine respective relative frequency of the data in the bins, and/or respective relative probability of data populating given bins and sub-divide the bins accordingly, such that bins having relatively higher relative frequencies and/or relative probabilities of the data, have relatively higher numbers of sub-bins, and bins having relatively lower relative frequencies and/or relative probabilities of the data, have relatively lower numbers of sub-bins. However, a given number of sub-bins of a bin is generally rounded to integer numbers.

Once a number of sub-bins for a given bin is determined, determination of relative widths of the sub-bins may be determined by dividing a bin by the number of sub-bins in the given bin (e.g., similar to dividing the range by a the given number of the bins). Otherwise determining the sub-bins for a given bin proceeds in a manner similar to as described above with respect to determining the bins.

In general, once the sub-bin generator engine 113 determines the sub-bins, the sub-bin generator engine 113 may populate the sub-bins with the data and/or further data received from the data collection devices. Such population may occur similar to as described above with respect to populating the bins, with collisions between adjacent sub-bins also resolved as described above with respect to the bins.

For example, the sub-bin generator engine 113 may populate the sub-bins using the data that was used to determine the sub-bins and/or the sub-bin generator engine 113 may populate the sub-bins using further data from the data collection devices. As such, it is understood that the sub-bins may be determined from historical data collected by a data collection device and/or data collection devices, and then used to determine parameter of further data collected by a data collection device and/or data collection devices Regardless, data populated in the sub-bins may be used to determine a parameter of the data.

The distribution of the data into the sub-bins results in a histogram that shows more detail of the data than if only distributed into the bins, which may result in a more accurate determination of statistical parameters (and the like) therefrom, while still maintaining privacy of the data. In particular, the data, as distributed into the sub-bins, may represent the data with details of raw data (e.g., as collected from the data collection devices) removed. For example, the data, as distributed into the sub-bins, may be transformed into a histogram format so that only numbers of data points of the raw data (and/or as randomized) in the sub-bins result, with the raw data otherwise discarded. The histogram may hence represent a reconstruction of the data but with details of the raw data removed, and/or may be used, to reconstruct the data with details of the raw data removed.

In particular, as depicted, the data parameter engine 115 is to: reconstruct the data, or the further data, based on distribution of the data, or the further data into the sub-bins; and determine a parameter of the data, or the further data, based on the data, or the further data, as reconstructed from the distribution into the sub-bins, the parameter being stored, at least temporarily in the memory or transmitted to an external device.

For example, as will be described below, the parameter is determined, not from raw data collected by the data collection devices, but from a histogram, and/or a reconstruction of the data, and the like, with details of the raw data removed as described above.

Such a parameter and/or parameters may include, but is not limited to a mean of the data, as distributed into the sub-bins (e.g., and/or as reconstructed therefrom), a standard deviation of the data, as distributed into the sub-bins (e.g., and/or as reconstructed therefrom), and/or any other suitable parameter and/or parameters. Furthermore, the data parameter engine 115 may convert the histogram to a line graph (and the like), with points of the line graph corresponding to the values of the histogram. Such a line graph may also represent a reconstruction of the data with details of the raw data removed. However, while examples of reconstruction of the data are described herein with respect to histograms, line graphs, and the like, it is understood that such histograms, line graphs, and the like may be produced within the data parameter engine 115 without actually being physically printed.

Once a parameter and/or parameters are determined, the system 100 may perform any other suitable functionality with the parameter and/or parameters. For example, the data parameter engine 115 may store the parameter and/or parameters, at least temporarily in a memory of the system 100 (and/or a memory accessible to the system 100) or transmitted to an external device. In a particular example, the system 100 may generate (e.g., and store) records therefrom and share (e.g., transmit), and/or publish (e.g., store in a memory) the records.

In yet further examples, the system 100 may determine, from the parameter and/or parameters, supplies (e.g., such as paper and/or ink) to be shipped to locations of the data collection devices (e.g., the parameter and/or parameters may indicate usage of paper and/or ink at printer devices, as described above) and cause such supplies to be shipped. For example, from the parameter and/or parameters may estimate when such supplies may need to be restocked at the data collection devices and cause such supplies to be shipped to locations of the data collection devices prior to such supplies being depleted at the data collection devices. However, any suitable process may be implemented using the parameter and/or parameters including, but not limited to, generating and storing reports that from the parameter and/or parameters based on analysis of the parameter and/or parameters.

In yet further examples, the system 100 may provide an indication of the sub-bins to the data collection devices to cause the data collection devices to collect and distribute collected data into the sub-bins. In these examples, the data collection devices collects data, distributes collected data into the sub-bins, and provides the collected data into the sub-bins to the system 100 where the data parameter engine 115 may determine a parameter and/or parameters therefrom, as described above. In some of these examples, collected data, received at the system 100, may be in a histogram format and/or partial aggregation format and/or batch summation format, and the like (e.g., any suitable format that show relative frequency of the data); for example, in such a formats, data from data collection devices may be provided as frequency of data points at given values of the same units used for the width of the bins and/or sub-bins, for example, and/or as relative numbers of data points at the given values. Hereafter, such formats are interchangeably referred to as relative frequency formats. Furthermore, the data as distributed into the sub-bins, provided to the system 100, by the data collection devices, may represent a reconstruction of the data, while removing details of the data in a raw form. Put another way, the data collection devices may collect the data in a raw form, distribute the data into the sub-bins (e.g., as counts of data points into the sub-bins) and provide the data, as distributed into the sub-bins, to the system 100, such that details of the data, in a raw form, are removed. Put yet another way, a histogram format and/or relative frequency format of the data, generated using the bins, removes details of specific data points of the data in the raw form, but rather indicates only where a data point falls into the sub-bins.

Such a relative frequency formats may also decrease the amount of data provided by the data collection devices as the relative frequency format may not include raw data points or randomized data points (though the raw data may be randomized prior to distributing into the sub-bins), but rather relative frequency of data points at given values. However, such data received in a relative frequency format may be processed, and the like, by the system 100 (e.g., the data parameter engine 115) to place into a frequency density format (e.g., by dividing data received in a relative frequency format by respective sub-bin size).

In yet further examples, the system 100 may periodically update the sizes of the bins and determine the sub-bins as further data is received from the data collection devices. Put another way, as more data is collected from the data collection devices, a more precise determination of the distribution of the data and/or the sub-bins may occur. Hence, the bin generator engine 111 and the sub-bin generator engine 113 may be further to respectively update respective sizes of the bins in the first data structure, and respective numbers of the sub-bins in the second data structure, based on the further data.

As previously mentioned, the data may be symmetrically distributed or unsymmetrically distributed. It has been heuristically determined that error in determination of parameters from randomized (e.g., using the Randomized Response Mechanism) and/or binned data (e.g., without sub-binning), as described herein, may be higher with unsymmetrically distributed data than with symmetrically distributed data. Hence, in some examples, the system 100 may determine a distribution type of the data (e.g., prior to binning and/or after binning) to determine whether the data is symmetrically distributed or unsymmetrically distributed, and the system 100 may refrain from determining the sub-bins, or the bins, in response to the distribution comprising a given distribution type. For example, the system 100 may refrain from determining the sub-bins, or the bins, in response to the distribution comprising symmetrical distribution type to avoid the additional processing to determine the sub-bins, as determination of the parameters using randomized and/or dithered data (and/or binned data) may be accurate enough. However, any suitable distribution type may be used to determine whether or not to determine the sub-bins.

However, in other examples sub-binning may occur regardless of distribution type.

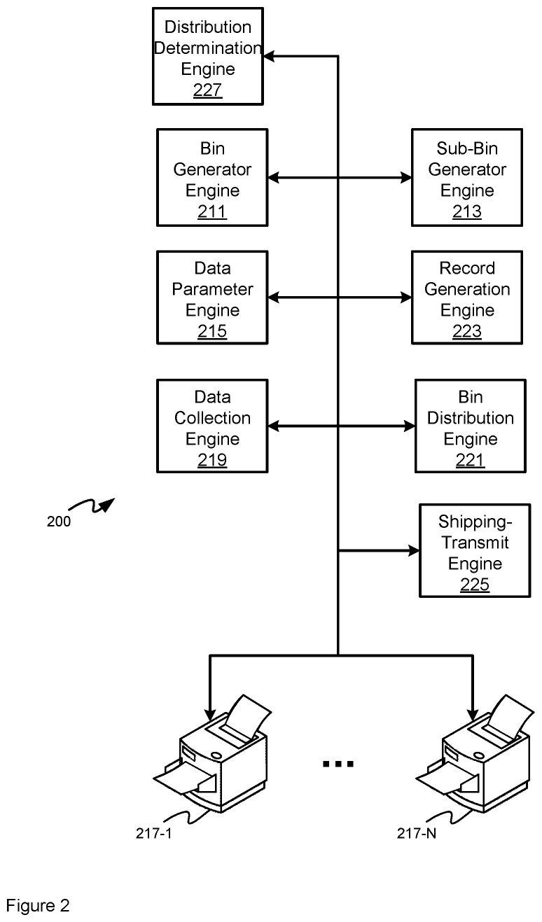

Attention is next directed to FIG. 2, which is a block diagram of another example system 200 to determine data parameters based on distribution of data. The system 200 is substantially similar to the system 100, with like components having like numbers, but in a “200” series rather than a “100” series. For example, the system 200 may include a bin generator engine 211, a sub-bin generator engine 213 and a data parameter engine 215, which are respectively substantially similar to the bin generator engine 111, the sub-bin generator engine 113, and the data parameter engine 115.

However, the system 200 further includes an “N” number of data collection devices 217-1 . . . 217-N, in particular, as depicted, printer devices. The data collection devices 217-1 . . . 217-N will be interchangeably referred to hereafter, collectively, as the data collection devices 217 and, generically, as a data collection device 217. This convention will be used throughput the present specification.

It is further understood that, while not depicted, the data collection devices 217 comprise respective engines, processors, memories, communication interfaces, and/or any other suitable hardware for performing functionality thereof, as described herein. Such communication interfaces may include any suitable combination of transceivers and/or network cards, and the like, for communicating with networks used to form communication links between the data collection devices 217 and other suitable components of the system 200.

The engines of the system 200 may be operated by an entity managing the data collection devices 217 and/or managing supply distribution to the data collection devices 217 (e.g., as a supply subscription service) and/or collecting and reporting on the data collection devices 217. The data collection devices 217 may be operated by entities different from the entity operating the engines of the system 200. Hence, a number “N” of the data collection devices 217 may be as few as one (N=1) data collection device 217, and may be as many as tens, hundreds and/or thousands (and/or higher) of the data collection devices 217 (e.g., N>1, with N being any suitable number).

As depicted, the system 200 comprises a data collection engine 219 to: receive data from the data collection devices 217. As such, the data collection engine 219 may be configured to communicate with the data collection devices 217 via any suitable communication network to receive data from the data collection devices 217. Data from the data collection devices 217 may be requested (e.g., periodically) by the provisioning data collection engine 219 from the data collection devices 217, and/or the data collection devices 217 may provide (e.g., periodically) data to the data collection engine 219 without a request therefrom. The data received at the data collection engine 219 may include data that is initially received in a provisioning mode, such that the sub-bins may be determined by the sub-bin generator engine 213, as well as further data received after the provisioning mode.

As depicted, the system 200 further comprises a bin distribution engine 221 to: provide an indication of the sub-bins to the data collection devices 217 to cause the data collection devices 217 to collect and distribute collected data into the sub-bins, as described above.

In some examples, functionality of the data collection engine 219 and the bin distribution engine 221 may be combined into one engine that communicates with the data collection devices 217.

Furthermore, the data collection engine 219 and the bin distribution engine 221 may respectively comprise, and/or share, a communication interface similar to as described above with respect to the data collection devices 217.

As depicted, the system 200 further comprises a record generation engine 223 to: generate a record based on a parameter and/or parameters of the data, as described above; and share or publish the record. For example, the record generation engine 223 may receive the parameter and/or parameters as determined by the data parameter engine 215 and generate a record therefrom, which may be in a database format, a message format, and the like, and the record may be stored in, and/or provided to, a memory (which may be external to the system 200). In particular, publication of records generated by the record generation engine 223 may include storage of the records in a memory, which may be publicly accessible and/or accessible to computing devices of subscribers to the records (e.g., and which may include, but is not limited to, entities operating the data collection devices 217).

As depicted, the system 200 further comprises a shipping-transmit engine 225 to: cause shipping or transmission of items to locations based on a parameter and/or parameters determined by the data parameter engine 215. Such items may include, but is not limited to, supplies, such as printer supplies (e.g., paper and/or ink), and the like, shipped to respective locations of the data collection devices 217; in such examples, the shipping-transmit engine 225 may communicate with a computing device of a shipping department to place an order for shipping supplies to respective locations of the data collection devices 217. However, in other examples, shipping-transmit engine 225 may communicate with a computing device of a manufacturing department to cause (and/or recommend) a number of data collection devices (e.g., printers) to be manufactured (e.g., per model category and the like).

In some examples, the shipping-transmit engine 225 may have access to records indicating when respective supplies where previously shipped to respective locations of the data collection devices 217, as well as respective quantities of such supplies, so that the shipping-transmit engine 225 may estimate, from the parameter and/or parameters determined by the data parameter engine 215, when given data collection devices 217 may need to be restocked with such supplies. Hence, the shipping-transmit engine 225 may cause respective supplies to be shipped to a respective location of a data collection device 217 prior to the data collection devices 217 running out of such supplies. Furthermore, such shipping may occur at different times, depending on quantities and times of respective supplies previously shipped to the respective locations of the data collection devices 217.

However, items provided by the shipping-transmit engine 225 may alternatively include the reports generated by the record generation engine 223 and/or any other suitable items. Hence, the shipping-transmit engine 225 may provide physical items and/or digital items and/or electronic items, and the like.

As previously mentioned, in some examples, the sub-binning (or the binning) may or may not occur based on a distribution type of the data (e.g., symmetric or unsymmetric). As such, the system 200 may include, as depicted, a distribution determination engine 227 to: determine a distribution type of data (e.g., previously collected data), such that the bin distribution engine 221 is further to: refrain from providing the sub-bins to the data collection devices 217, in response to the distribution type comprising a given distribution type, such that: the collected data, as received from the data collection devices 217 is not binned, and the parameter is determined (e.g., by the data parameter engine 215) based on the collected data as not binned. Indeed, in these examples, the distribution type may further disable the bin generator engine 211 and the sub-bin generator engine 213 such that collected data is not binned.

Hence, in general, the bin generator engine 211 to: divide a range of data into a number of bins of equal size; and populate the bins with the data.

The sub-bin generator engine 213 is to: sub-divide the bins into respective sub-bins based on a relative frequency of the data in the bins; and populate the sub-bins with the data or further data.

The data parameter engine 215 is to: determine a parameter of the data, or the further data, based on distribution of the data, or the further data, into the sub-bins.

The data collection engine 219 is to: receive the data and the further data from the data collection devices 217.

Furthermore, in some examples, the bin generator engine 211 and the sub-bin generator engine 213 may be further to respectively update respective sizes of the bins, and respective numbers of the sub-bins, based on the further data, and the data parameter engine may be further to: determine the parameter of the further data based on updated sizes of the bins, and updated numbers of the sub-bins, with the further data distributed therein.

The record generation engine 223 is to: generate a record based on the parameter of the data; and share or publish the record.

The bin distribution engine 221 is to: provide an indication of the sub-bins to the data collection devices 217 to cause the data collection devices 217 to collect and distribute collected data into the sub-bins. In these examples, the data collection engine 219 may be further to: receive the collected data from the data collection devices, as distributed into the sub-bins. Similarly, in these examples, the data parameter engine 215 may be further to: determine the parameter of the collected data based on distribution of the collected data into the sub-bins, as received from the data collection devices 217. Put another away, in examples where the data collection devices 217 performs sub-binning the bin generator engine 211 and the sub-bin generator engine 213 may be to initially determine the bins and the sub-bins, and optionally update the bins and/or sub-bins, for example periodically and/or as more data is collected.

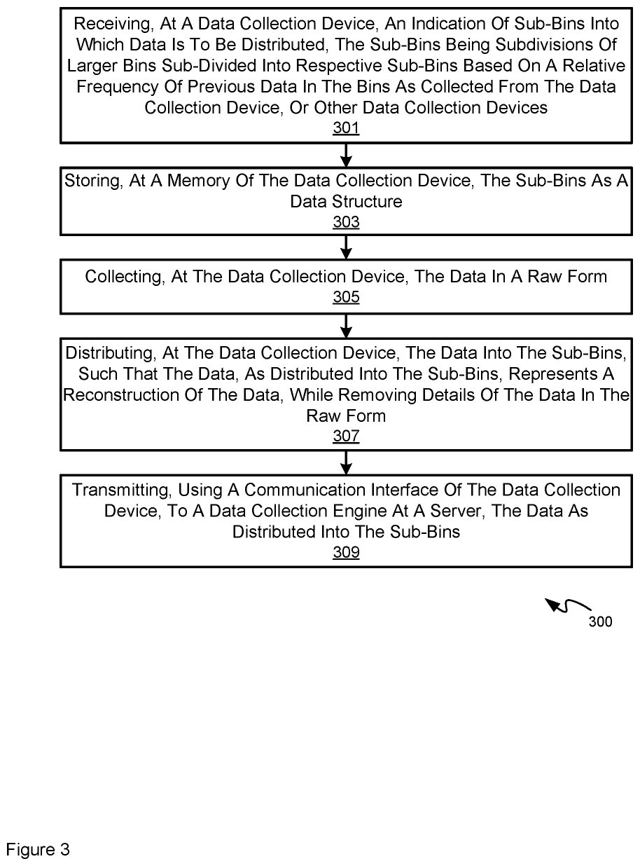

Referring to FIG. 3, a flowchart of an example method 300 to determine data parameters based on distribution of data is depicted. In order to assist in the explanation of method 300, it will be assumed that method 300 may be performed at least partially by the data collection devices 217, and/or a processor thereof, implementing the method 300. Indeed, the method 300 may be one way in which the system 200 and/or the data collection devices 217 may be configured. Furthermore, the following discussion of method 300 may lead to a further understanding of the system 200, and its various components. Furthermore, it is to be emphasized, that method 300 may not be performed in the exact sequence as shown, and various blocks may be performed in parallel rather than in sequence, or in a different sequence altogether.

Beginning at a block 301, a data collection device 217 receives, an indication of sub-bins into which data is to be distributed. As previously described, the sub-bins may be subdivisions of larger bins sub-divided into respective sub-bins based on a relative frequency of previous data in the bins as collected from the data collection device 217, or other data collection devices 217 (e.g., the sub-bins may be determined from historical data collected by the data collection devices 217). The indication of the sub-bins received at the block 301 may hence comprise respective ranges of the sub-bins into which data collected by the data collection device 217 is to be distributed.

At a block 303, the data collection device 217 stores, at a memory of the data collection device 217, the sub-bins as a data structure such that data collected by the data collection device 217 may be distributed into the sub-bins of the data structure in a binning process.

At a block 305, the data collection device 217 collects the data in a raw form. For example, as the data collection device 217 performs functionality thereof, such as printing documents, the data collection device 217 determines operational factors thereof, such as collecting respective numbers of pages, and respective ink used, for printing respective documents. Such collection of data in a raw form may be performed via sensors of the data collection device 217 which count numbers of pages printed and/or used, amounts of ink used, and the like.

Hence, the data may indicate use of supplies for operating the data collection device 217, however the data may indicate any other suitable operational factor. For example, when a data collection device comprises an IoT device, the data may indicate operational factors which may include, but is not limited to, power used, battery degradation, measured temperatures, bandwidth usage, storage usage, processor performance factors, and/or any other suitable factor, as previously described.

At a block 307, the data collection device 217 distributes the data into the sub-bins received in the indication of the block 301 such that the data, as distributed into the sub-bins, represents a reconstruction of the data, while removing details of the data in the raw form.

In some examples the data collection device 217 may further randomize and/or dither the data, as has been previously described, while distributing the data into the bins and the sub-bins.

At a block 309, the data collection device 217 transmits, using a communication interface of the data collection device 271, to a data collection engine at a server (e.g., the data collection engine 219), the data as distributed into the sub-bins. For example, the data collection device 217 may transmit, using a communication interface, the data as distributed into the sub-bins to the data collection engine 219. In some examples, the data collection device 217 provides the data as distributed into the sub-bins, to a data collection engine at a server (e.g., the data collection engine 219) as the data is generated, for example in a streaming manner; in other examples, the data collection device 217 provides the data as distributed into the sub-bins, to a data collection engine at a server (e.g., the data collection engine 219) in batches and/or periodically (e.g., and as aggregated over a given time period being transmission of the data).

In some examples, the data as distributed into the sub-bins may be transmitted as individual counts of the data points of the data (e.g., In a raw format) grouped into the sub-bins (e.g., in a histogram) and/or, the data as distributed into the sub-bins may be transmitted in a relative frequency format, as described above.

As has been previously described, the components of the system 200 may be initially operated in a provisioning mode. Hence, in some examples, the method 300 may further comprise the data collection device 217, prior to receiving the indication of the sub-bins at the block 301: collecting initial data; randomizing and/or dithering the initial data (e.g., to protect privacy thereof; and providing, to the data collection engine 219 at a server, the initial data for use in determining the bins and the sub-bins at the server (e.g., via the engines 211, 213, as described above). Hence, in these examples, the data collection device 217 is operated in a provisioning mode to collect and provide data to the engines 211, 213 to determine the sub-bins, which are then received in the indication at the block 301.

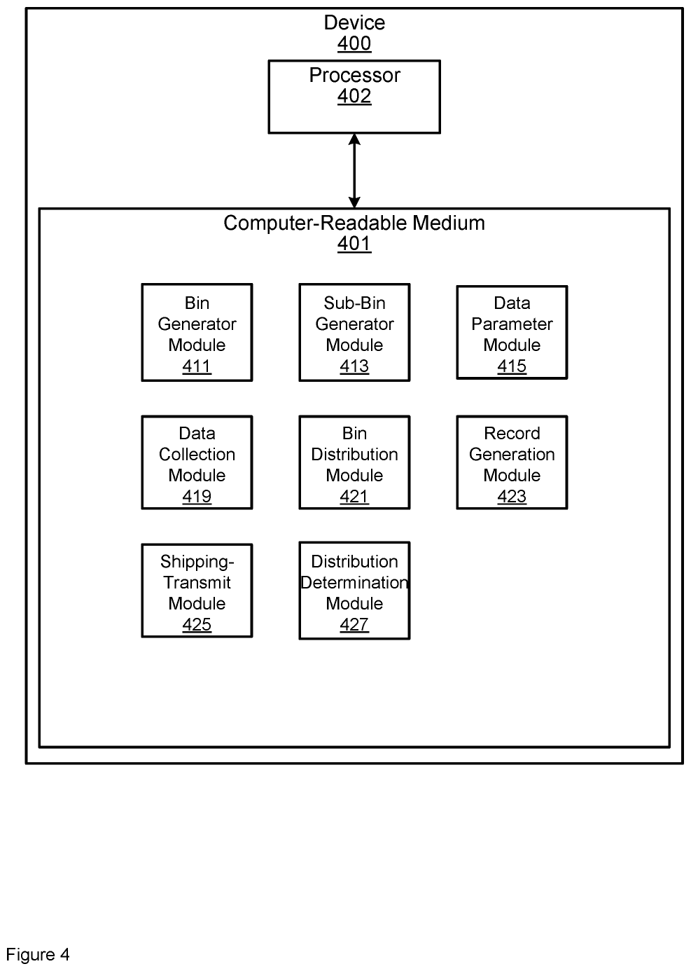

FIG. 4 is a block diagram of an example device 400 that includes a computer-readable medium 401 and a processor 402. The computer-readable medium 401 includes instructions that, when implemented by the processor 402, cause the processor 402 to determine data parameters based on distribution of data. While not depicted, the device 400 may include a communication interface to communicate with the data collection devices 217.

The computer-readable medium 401 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like.

The processor 402 may be a general-purpose processor or special purpose logic, such as a microprocessor (e.g., a central processing unit, a graphics processing unit, etc.), a digital signal processor, a microcontroller, an ASIC, an FPGA, a PAL (programmable array logic), a PLA (programmable logic array), a PLD (programmable logic device), etc. The computer-readable medium 401 or the processor 402 may be distributed among a plurality of computer-readable media or a plurality of processors.

The computer-readable medium 401 includes modules. As used herein, a “module” (in some examples referred to as a “software module”) is a set of instructions that when implemented or interpreted by a processor or stored at a processor-readable medium realizes a component or performs a method.

As depicted, the computer-readable medium 401 includes various modules which correspond to functionality of the engines of the system 200.

In particular the computer-readable medium 401 includes a bin generator module 411, which, when processed by the processor 402, may provide the processor 402 with functionality similar to the bin generator engine 211. Hence, in general, the bin generator module 411 to: divide a range of data into a number of bins of equal size; and populate the bins with the data.

The computer-readable medium 401 includes a sub-bin generator module 413, which, when processed by the processor 402, may provide the processor 402 with functionality similar to the sub-bin generator engine 213. Hence, the sub-bin generator module 413 is to: sub-divide the bins into respective sub-bins based on a relative frequency of the data in the bins; and populate the sub-bins with the data or further data.

The computer-readable medium 401 includes a data parameter module 415, which, when processed by the processor 402, may provide the processor 402 with functionality similar to the data parameter engine 215. Hence, the data parameter module 415 is to: determine a parameter of the data, or the further data, based on distribution of the data, or the further data, into the sub-bins.

As described above, in some examples, the collected data may comprise use of a first supply (e.g., paper) at the data collection devices 217 as a function of use of a second supply (e.g., ink) at the data collection devices 217. In particular examples, a parameter determined by the data parameter module 415 may comprises a statistical parameter of use of: paper or ink by the data collection devices 217 and/or printer devices (e.g., when the data collection devices 217 comprise printer devices).

The computer-readable medium 401 includes a data collection module 419, which, when processed by the processor 402, may provide the processor 402 with functionality similar to the data collection engine 219. Hence, the data collection module 419 is to: receive the data and the further data from the data collection devices 217. In some examples, the data collection module 419 may be to: receive collected data from the data collection devices 217, as distributed into respective sub-bins (e.g., when the data collection devices 217 perform the functionality as described above with respect to the method 300).

The computer-readable medium 401 includes a bin distribution module 421, which, when processed by the processor 402, may provide the processor 402 with functionality similar to the bin distribution engine 221. Hence, the bin distribution module 421 is to: provide an indication of the sub-bins to the data collection devices 217 to cause the data collection devices 217 to collect and distribute collected data into the sub-bins. Put another way, the bin distribution module 421 is to: provide, to data collection devices 217, an indication of respective sub-bins, the sub-bins being subdivisions of bins sub-divided into respective sub-bins based on a relative frequency of previously collected data in the bins, as collected from the data collection devices 217.

The computer-readable medium 401 includes a record generation module 423, which, when processed by the processor 402, may provide the processor 402 with functionality similar to the record generation engine 223. Hence, the record generation module 423 is to: generate a record based on the parameter of the data; and share or publish the record.

The computer-readable medium 401 includes a shipping-transmit module 425, which, when processed by the processor 402, may provide the processor 402 with functionality similar to the shipping-transmit engine 225. Hence, the shipping-transmit module 425 is to: cause shipping or transmission of items to locations based on the parameter (e.g., determined by the data parameter module 415).

As has been previously described, in some examples, the data collection devices 217 may comprise printer devices, and the parameter determined by the data parameter module 415 may comprise a printer-supplies-related parameter. In these examples, the shipping-transmit module 425 may be further to cause respective printer supplies to be shipped to the locations at which the printer devices are located, by: transmitting a message to a shipping communication device (not depicted), for example as operated by a shipping department of the entity operating the system 200 (and/or another suitable entity).

The computer-readable medium 401 includes a distribution determination module 427, which, when processed by the processor 402, may provide the processor 402 with functionality similar to the distribution determination engine 227. Hence, the distribution determination module 427 is to: determine a distribution type of previously collected data. In these examples, the bin distribution module 421 is further to: refrain from providing the sub-bins in response to the distribution type comprising a given distribution type, such that: the collected data, as received from the data collection devices 217 (e.g., via the data collection module 419) is not binned, and the parameter (e.g., determined via the data parameter module 415) is determined based on the collected data as not binned.

While not depicted, a data collection device 217 may have a similar structure to that of the device 400 and may include a respective processor and a respective computer-readable medium storing instructions that, when implemented by a respective processor, cause the respective processor to implement the method 300. For example, the respective computer-readable medium may store any suitable number of modules for implementing the method 300. Furthermore, a data collection device 217 may include any suitable number of engines corresponding to such modules.

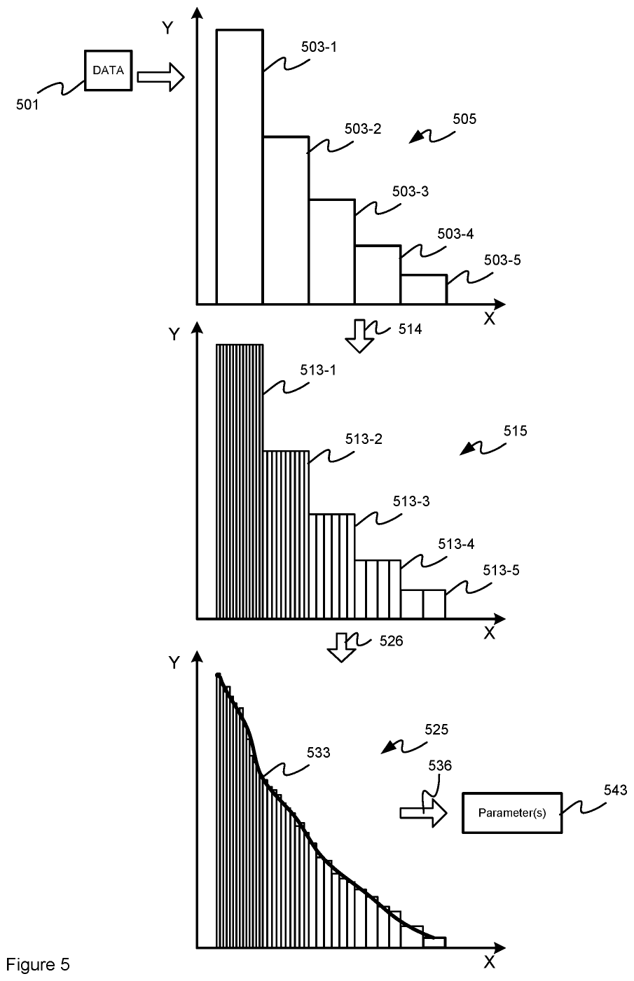

Attention is next directed to FIG. 5 which depicts a graphical example of determining bins and sub-bins. It is understood that the examples shown in FIG. 5 may be implemented by the system 100 and/or the system 200. Hence, while hardware components and/or engines are not depicted in FIG. 5, the example of FIG. 5 is understood to be implemented by suitable hardware components and/or engines as described herein.

As depicted, data 501 is received (e.g., via the data collection engine 219, from the data collection devices 217) and from the data 501, bins 503-1, 503-2, 503-4, 503-5 (e.g., bins 503 and/or a bin 503) are determined. As depicted the bins 503 are shown in a histogram 505, with a “Y” value thereof shown as a function of an X″ value thereof. For example, the data 501 may comprises numbers of pages printed (e.g., “Y”) vs amount of ink used (e.g., “X”).

As depicted, it is understood that a range of the data 501 has been determined and that a given number of the bins 503 has been determined to be “5”, though the given number of the bins 503 may be any suitable number. As is also understood from FIG. 5, the bins 503 are of equal sizes and/or width along an “X” axis of the histogram 505. Furthermore, it is understood that the data 501 has been used to populate the bins 503 such that a relative height of the bins 503 along a “Y” axis of the histogram 505 shows a relative frequency of the data 501 in the bins 503. For example, as depicted, the bin 503-1 includes the highest frequency of data points of the data 501, the bin 503-2 includes the second highest frequency of data points of the data 501, the bin 503-3 includes the third highest frequency of data points of the data 501, the bin 503-4 includes the fourth highest frequency of data points of the data 501, and the bin 505-1 includes the lowest frequency of data points of the data 501.

The bins 503 and/or the histogram 505 may be determined by the bin generator engine 111 and/or the bin generator engine 211.

As depicted, sub-bins 513-1, 513-2, 513-4, 513-5 (e.g., sub-bins 513 and/or a sub-bin 513) are determined (e.g., by the sub-bin generator engine 113 and/or the sub-bin generator engine 213) from the bins 503 and the relative frequencies of the data 501 therein (e.g., as represented by the arrow 514). For example, as depicted, the sub-bins 513 are arranged in a histogram 515 and, comparing with the histogram 505, it is understood that the sub-bins 513-1 are subdivisions of the bin 503-1, the sub-bins 513-2 are subdivisions of the bin 503-2, the sub-bins 513-3 are subdivisions of the bin 503-3, the sub-bins 513-4 are subdivisions of the bin 503-4, and the sub-bins 513-5 are subdivisions of the bin 503-5.

Furthermore, as the bin 503-1 had the highest frequency of the data 501, a number of the corresponding sub-bins 513-1 is higher than respective numbers of other sub-bins 513. Similarly, as the bin 503-5 had the lowest frequency of the data 501, a number of the corresponding sub-bins 513-5 is lower than respective numbers of other sub-bins 513. Similarly, respective numbers of the sub-bins 513-2, 513-3, 513-4 have corresponding respective numbers therebetween, according to the respective frequency of the data 501 in corresponding bins 503-2, 503-3, 503-4.

As also depicted in FIG. 5, in a histogram 525, the data 501 may be used to populate the sub-bins 513 (e.g., as represented by the arrow 526) such that a relative height of the sub-bins 513 along a “Y” axis of the histogram 525 shows a relative frequency of the data 501 in the sub-bins 513. As such, the histogram 525 represents a reconstruction of the data 501 with details thereof removed; for example, details of individual data points of the data 501 are not present in the histogram 525.

A line 533 may be fitted to the histogram 525 (e.g., by the data parameter engine 115 and/or the data parameter engine 215). Such a line 533 may also represents a reconstruction of the data 501 with details thereof removed; for example, details of individual data points of the data 501 are not present in the line 533.

The histogram 525 and/or the line 533 may be used to determine (e.g., as represented by the arrow 536) a parameter 543 (and/or parameters), such as a mean and/or a standard deviation of the data 501 and/or any other suitable statistical parameter.

In general, the parameter 543 may be similar as to when the same parameter is determined from the data 501 prior to sub-binning; however specific details of the data 501, as sub-binned, are generally hidden so as to protect privacy of the data 501 and/or to prevent a malicious entity from identifying a data collection device 217 and/or an entity operating a data collection device 217.

Indeed, it is understood that the sub-bins 513 may be provided to the data collection devices 217 such that further data from the data collection devices 217 may be received already sub-binned in the histogram 525 such that the engines of the systems 100, 200 do not have access to underlying raw data from which the further data, as sub-binned was generated. While data, received as sub-binned from the data collection devices 217, may be in a relative frequency format, such data may be converted to a histogram similar to that of the histogram 525 by dividing frequency density of the relative frequency format by respective bin sizes. Furthermore, data, received as sub-binned from the data collection devices 217 may be aggregated by engines of the system 100, 200 such that data from a plurality of data collection devices 217 is aggregated by the systems 100, 200 (e.g., to form histograms similar to the histograms 505, 515, 525).

It is further understood that the example depicted in FIG. 5 shows an unsymmetrical distribution type, and that in other examples data may be of a symmetrical distribution type, in which case binning and/or sub-binning may not occur, but privacy may be protected via randomization and/or dithering.

It should be recognized that features and aspects of the various examples provided above may be combined into further examples that also fall within the scope of the present disclosure.

1. A system comprising:
a bin generator engine to: divide a range of data into bins of equal size; and populate the bins with the data, the bins comprising a first data structure at least temporarily stored in a memory;
a sub-bin generator engine to: sub-divide the bins into respective sub-bins based on a relative frequency of the data in the bins; and populate the sub-bins with the data or further data, the sub-bins comprising a second data structure at least temporarily stored in a memory; and
a data parameter engine to: reconstruct the data, or the further data, based on distribution of the data, or the further data into the sub-bins; and
determine a parameter of the data, or the further data, based on the data, or the further data, as reconstructed from the distribution into the sub-bins, the parameter being stored, at least temporarily in the memory or transmitted to an external device.

2. The system of claim 1, further comprising:
a record generation engine to: generate a record based on the parameter of the data; and share or publish the record.

3. The system of claim 1, further comprising:
a data collection engine to: receive the data and the further data from data collection devices, and
wherein the bin generator engine and the sub-bin generator engine are further to respectively update respective sizes of the bins in the first data structure, and respective numbers of the sub-bins in the second data structure, based on the further data, and
wherein the data parameter engine is further to: determine the parameter of the further data based on updated sizes of the bins, and updated numbers of the sub-bins, with the further data distributed therein.

4. The system of claim 1, further comprising:
a bin distribution engine to: provide an indication of the sub-bins to data collection devices to cause the data collection devices to collect and distribute collected data into the sub-bins; and
a data collection engine to: receive the collected data from the data collection devices, as distributed into the sub-bins,
wherein the data parameter engine is further to: determine the parameter of the collected data based on distribution of the collected data into the sub-bins.

5. The system of claim 4, wherein the collected data is received in a relative frequency format.

6. A method comprising:
receiving, at a data collection device, an indication of sub-bins into which data is to be distributed, the sub-bins being subdivisions of larger bins sub-divided into respective sub-bins based on a relative frequency of previous data in the bins as collected from the data collection device, or other data collection devices;
storing, at a memory of the data collection device, the sub-bins as a data structure;
collecting, at the data collection device, the data in a raw form;
distributing, at the data collection device, the data into the sub-bins such that the data, as distributed into the sub-bins, represents a reconstruction of the data, while removing details of the data in the raw form; and
transmitting, using a communication interface of the data collection device, to a data collection engine at a server, the data as distributed into the sub-bins.

7. The method of claim 6, further comprising randomizing the data, while distributing the data into the sub-bins.

8. The method of claim 6, wherein the data, as distributed into the sub-bins, is in a relative frequency format.

9. The method of claim 6, wherein the data indicates use of supplies for operating the data collection device.

10. The method of claim 6, further comprising, prior to receiving the indication of the sub-bins:
collecting, at the data collection device, initial data;
dithering the initial data; and
providing, from the data collection device, to the data collection engine at the server, the initial data for use in determining the bins and the sub-bins at the server.

11. A non-transitory computer-readable medium comprising instructions that, when executed by a processor, cause the processor to:
execute a bin distribution module to: provide, to data collection devices, an indication of respective sub-bins, the sub-bins being subdivisions of bins sub-divided into respective sub-bins based on a relative frequency of previously collected data in the bins, as collected from the data collection devices;
execute a data collection module to: receive collected data from the data collection devices, as distributed into the respective sub-bins;
execute a data parameter module to: determine a parameter of the collected data based on distribution of the collected data into the sub-bins; and
execute a shipping-transmit module to: cause shipping or transmission of items to locations based on the parameter.

12. The non-transitory computer-readable medium of claim 11, wherein the instructions, when executed by the processor, further cause the processor to:
execute a distribution determination module to: determine a distribution type of the previously collected data,
wherein the bin distribution module is further to: refrain from providing the sub-bins in response to the distribution type comprising a given distribution type, such that:
the collected data, as received from the data collection devices is not binned, and
the parameter is determined based on the collected data as not binned.

13. The non-transitory computer-readable medium of claim 11, wherein:
the collected data comprises use of a first supply at the collection devices as a function of use of a second supply at the collection devices.

14. The non-transitory computer-readable medium of claim 11, wherein the data collection devices comprise printer devices, and the parameter comprises a statistical parameter of use of:
paper or ink by the printer devices.

15. The non-transitory computer-readable medium of claim 11, wherein the data collection devices comprise printer devices, and the parameter comprises a printer-supplies-related parameter, and wherein the instructions, when executed by the processor, further cause the processor to:
execute the shipping-transmit module to cause respective printer supplies to be shipped to the locations at which the printer devices are located, by: transmitting a message to a shipping communication device.
